(19) United States
(12) Patent Application Publication
(10) Pub. No.: US 2022/0336822 A1
(43) Pub. Date: Oct. 20, 2022

(54) HIGH PERFORMANCE PLATINUM-BASED CATALYST COMBINED WITH CARBON SUPPORT ENGINEERING

(71) Applicant: THE REGENTS OF THE UNIVERSITY OF CALIFORNIA, Oakland, CA (US)

(72) Inventors: Yu Huang, Los Angeles, CA (US); Zipeng Zhao, Los Angeles, CA (US)

(73) Assignee: THE REGENTS OF THE UNIVERSITY OF CALIFORNIA, Oakland, CA (US)

(21) Appl. No.: 17/762,663

(22) PCT Filed: Sep. 24, 2020
(86) PCT No.: PCT/US2020/052453

§ 371 Date: Mar. 22, 2022

Related U.S. Application Data
(60) Provisional application No. 62/905,564, filed on Sep. 25, 2019.

(51) Int. Cl. H01M 4/92; C22F 1/02; C22F 1/14

(52) U.S. Cl. CPC H01M 4/923; C22F 1/02; C22F 1/14; H01M 4/926

(57) ABSTRACT

Provided herein are improved Pt-based electrochemical catalyst (or electrocatalyst) for ORR, exhibiting a combination of high activity and high stability, along with reduced usage of scarce Pt. The Pt-based electrocatalyst is loaded on a catalyst support, which is developed through carbon engineering to impart improved performance to the Pt-based electrocatalyst.

### CROSS-REFERENCE TO RELATED APPLICATIONS

This application claims the benefit of and priority to U.S. patent application Ser. No. 62/905,564, filed on Sep. 25, 2019, the contents of which are incorporated herein in their entirety.

### STATEMENT REGARDING FEDERALLY SPONSORED RESEARCH OR DEVELOPMENT

This invention was made with government support under Grant Number N00014-18-1-2155, awarded by the U.S. Navy, Office of Naval Research. The government has certain rights in the invention.

### BACKGROUND

Proton-exchange membrane (PEM) fuel cells are desirable energy conversion devices for applications such as transportation vehicles and portable electronic devices, due to their high-energy density and low environmental impact in addition to being light-weight and affording low-temperature operation. PEM fuel cells operate based on reactions of a fuel (such as hydrogen or an alcohol) at an anode and an oxidant (molecular oxygen) at a cathode. Both cathode and anode reactions include catalysts to lower their electrochemical over-potential for high-voltage output, and so far, platinum (Pt) has been the leading choice. To fully realize the commercial viability of fuel cells, the following challenges should be addressed: the high cost of Pt, the sluggish kinetics of the oxygen reduction reaction (ORR), and the low stability of Pt-based catalysts.

The operation of a fuel cell involves the reaction at a three-phase interface, which is the interface of a reactant gas, a solid catalyst, and protons in a polymer electrolyte, in a catalyst layer of a PEM fuel cell. The performance of state-of-the-art Pt alloy catalyst can be compromised by the constraint of reactant transfer, which can involve the proton transfer at the polymer electrolyte and gas transfer within a porous carbon support, at the three-phase interface. Previously, intensive efforts have focused on the intrinsic activity and stability of alloys of Pt, while ignoring consideration of the impact of the catalyst support, which affects the proton and gas transfer via the interaction between the carbon support and the polymer electrolyte, on overall fuel cell performance.

It is against this background that a need arose to develop the embodiments described herein.

### SUMMARY OF THE DISCLOSURE

Certain aspects of the disclosure include a manufacturing method comprising: subjecting a catalyst support to reductive treatment; and reacting a Pt-containing precursor and a N-containing precursor in a liquid medium in the presence of the catalyst support to form PtN nanostructures affixed to the catalyst support. In some embodiments, the catalyst support is a carbonaceous support. In some embodiments, subjecting the catalyst support to reductive treatment includes annealing the catalyst support in a reducing environment. In some embodiments, the catalyst support has an initial surface oxygen to carbon (O/C) atomic ratio prior to reductive treatment, and the catalyst support subsequent to reductive treatment has a subsequent surface O/C atomic ratio, and the subsequent surface O/C atomic ratio is smaller than the initial surface O/C atomic ratio. In some embodiments, N is Ni, Co, Cu, or Ag. In some embodiments, the method further comprises annealing the PtN nanostructures affixed to the catalyst support in a reducing environment. In some embodiments, the method further comprises exposing the PtN nanostructures affixed to the catalyst support to an acid.

Certain aspects of the disclosure include a manufacturing method comprising: subjecting a catalyst support to reductive treatment; and reacting a Pt-containing precursor, a N-containing precursor, and a M-containing precursor in a liquid medium in the presence of the catalyst support to form PtNM nanostructures affixed to the catalyst support. In some embodiments, the catalyst support is a carbonaceous support. In some embodiments, subjecting the catalyst support to reductive treatment includes annealing the catalyst support in a reducing environment. In some embodiments, the catalyst support has an initial surface oxygen to carbon (O/C) atomic ratio prior to reductive treatment, and the catalyst support subsequent to reductive treatment has a subsequent surface O/C atomic ratio, and the subsequent surface O/C atomic ratio is smaller than the initial surface O/C atomic ratio. In some embodiments, N is Ni, Co, Cu, or Ag, and M is a transition metal different from N. In some embodiments, N and M are different transitional metals selected from Ni, Co, Cu, and Ag. In some embodiments, the method further comprises annealing the PtNM nanostructures affixed to the catalyst support in a reducing environment.

In some embodiments, the method further comprises exposing the PtNM nanostructures affixed to the catalyst support to an acid.

### BRIEF DESCRIPTION OF THE DRAWINGS

FIG. 1 shows a schematic of a fuel cell according to an embodiment of this disclosure.

FIG. 2 shows a schematic of a metal-air battery according to an embodiment of this disclosure.

FIGS. 3A-3F: 3(a) shows a BET nitrogen adsorption-desorption isothermal plots of carbon supports. FIG. 3(b) shows density function theory (DFT) pore size distribution based on BET isothermal plots. Transmission electron microscopy (TEM) images of carbon materials are shown in FIG. 3(c) C-1, FIG. 3(d) C-2, and FIG. 3(e) C-3. FIG. 3(f) shows x-ray powder diffraction (XRD) spectra of carbon materials.

FIG. 4 shows synchrotron based characterization of carbon materials (C-1, C-2, C-3). FIG. 4(a) shows X-ray photoelectron spectroscopy (XPS) spectra of carbon materials oxygen is. FIG. 4(b) shows XPS spectra of carbon materials carbon is (the inserted oxygen/carbon intensity ratio is normalized by photoionization cross-section). FIGS. 4(c) and 4(d) show near-edge X-ray absorption fine structure (NEXAFS) spectra of carbon materials FIG. 4(c) oxygen K edge and FIG. 4(d) carbon K edge.

### DETAILED DESCRIPTION

Certain embodiments of this disclosure are directed to an improved Pt-based electrochemical catalyst (or electrocatalyst) for ORR, exhibiting a combination of high activity and high stability, along with reduced usage of scarce Pt. The Pt-based electrocatalyst is loaded on a catalyst support, which is developed through carbon engineering to impart improved performance to the Pt-based electrocatalyst.

In some embodiments, a Pt-based electrocatalyst is an alloy of Pt and at least one secondary metal, namely N. In some embodiments, the Pt-based electrocatalyst has a chemical composition that can be represented by the formula PtₐN_{b} where any one or any combination of two or more of the following applies: (1) Pt represents platinum as a primary metal; (2) N represents a secondary metal that is different from Pt, such as where N is at least one transition metal selected from Group 3, Group 4, Group 5, Group 6, Group 7, Group 8, Group 9, Group 10, Group 11, and Group 12 of the Periodic Table; (3) “a” represents a molar content (e.g., expressed as a percentage) of Pt, and “b” represents a molar content of N, with a>b; (4) “a” has a non-zero value in a range of about 51 to about 85, such as about 51 to about 80, about 55 to about 80, about 60 to about 80, about 60 to about 70, or about 65 to about 90; (5) “b” has a non-zero value in a range of about 15 to about 49, such as about 20 to about 49, about 20 to about 45, about 20 to about 40, about 30 to about 40, or about 10 to about 35; and (6) subject to the condition that a+b =100 (or 100%). In some embodiments, N is nickel (Ni), cobalt (Co), copper (Cu), or silver (Ag).

In some embodiments, a Pt-based electrocatalyst is an alloy of Pt and at least two secondary metals, namely N and M. In some embodiments, the Pt-based electrocatalyst has a chemical composition that can be represented by the formula PtaNbMc where any one or any combination of two or more of the following applies: (1) Pt represents platinum as a primary metal; (2) N represents a secondary metal and with N being different from Pt, such as where N is at least one transition metal selected from Group 3, Group 4, Group 5, Group 6, Group 7, Group 8, Group 9, Group 10, Group 11, and Group 12 of the Periodic Table; (3) M represents an additional secondary metal and with M being different from Pt and N, such as where M is at least one transition metal selected from Group 3, Group 4, Group 5, Group 6, Group 7, Group 8, Group 9, Group 10, Group 11, and Group 12 of the Periodic Table; (4) “a” represents a molar content (e.g., expressed as a percentage) of Pt, “b” represents a molar content of N, and “c” represents a molar content of M, with a>b, a>c, and also, in some embodiments, b≥c or c≥b or b being about the same as c; (5) “a” has a non-zero value in a range of about 51 to about 85, such as about 51 to about 80, about 55 to about 80, about 60 to about 80, about 60 to about 70, or about 65 to about 90; (6) “b” has a non-zero value in a range of about 5 to about 49, such as about 5 to about 40, about 5 to about 35, about 5 to about 30, about 5 to about 25, about 10 to about 20, or about 10 to about 25; (7) “c” has a non-zero value in a range of about 5 to about 49, such as about 5 to about 40, about 5 to about 35, about 5 to about 30, about 5 to about 25, about 10 to about 20, or about 10 to about 25; and (8) subject to the condition that a+b+c=100 (or 100%). In some embodiments, N is Ni, Co, Cu, or Ag, and M is a transition metal different from N. In some embodiments, N and M are different transitional metals selected from Ni, Co, Cu, and Ag.

In some embodiments, post-synthesis annealing of a Pt-based electrocatalyst forms an exterior shell of Pt, which can be beneficial in impeding leaching of a transition metal (e.g., N or M) during operation that can lead to PEM poisoning. In some embodiments, a molar content of Pt within the exterior shell is greater than a molar content of Pt within a core surrounded by the exterior shell, such as at least about 1.05 times greater, at least about 1.1 times greater, at least about 1.15 times greater, or at least about 1.2 times greater. In some embodiments, at least about 70%, at least about 80%, at least about 90%, or at least about 95% of atoms located within a depth of 5 atomic layers from an exterior of a nanostructure, such as within 4 atomic layers, within 3 atomic layers, or within 2 atomic layers, are Pt atoms.

In some embodiments, a Pt-based electrocatalyst includes multiple nanostructures having the above-noted chemical composition, where any one or any combination of two or more of the following applies: (1) the nanostructures have sizes (or have an average size) in a range of up to about 100 nm, up to about 50 nm, up to about 40 nm, up to about 30 nm, up to about 20 nm, up to about 15 nm, up to about 10 nm, up to about 9 nm, up to about 8 nm, up to about 7 nm, up to about 6 nm, up to about 5 nm, or up to about 4.5 nm, and down to about 4 nm, down to about 3.5 nm, or less; (2) the nanostructures have at least one dimension or extent (or have at least one average dimension or extent) in a range of up to about 100 nm, up to about 50 nm, up to about 40 nm, up to about 30 nm, up to about 20 nm, up to about 15 nm, up to about 10 nm, up to about 9 nm, up to about 8 nm, up to about 7 nm, up to about 6 nm, up to about 5 nm, or up to about 4.5 nm, and down to about 4 nm, down to about 3.5 nm, or less; (3) the nanostructures have aspect ratios (or have an average aspect ratio) in a range of up to about 3, such as about 1 to about 3, about 1 to about 2.5, about 1 to about 2, or about 1 to about 1.5, or in a range of greater than about 3, such as about 4 or greater, about 5 or greater, or about 10 or greater; and (4) the nanostructures are largely or substantially crystalline, such as with a percentage of crystallinity (by volume or weight) of at least about 50%, at least about 60%, at least about 70%, at least about 80%, at least about 90%, at least about 95%, at least about 98%, or at least about 99% or more. Nanostructures of a Pt-based electrocatalyst can have a variety of morphologies, such as in the form of octahedra having exposed {111} facets, although other morphologies are encompassed by this disclosure, including nanoparticles, nanorods, nanowires, or other elongated nanostructures having aspect ratios greater than about 3, as well as core-shell nanostructures, core-multi-shell nanostructures, and nanoparticle-decorated cores, among others.

In some embodiments, a Pt-based electrocatalyst includes multiple nanostructures that are loaded on, dispersed in, affixed to, anchored to, or otherwise connected to a catalyst support, such as carbon black. In place of, or in combination with, carbon black, another catalyst support having suitable electrical conductivity can be used, such as another carbon-based or carbonaceous support in the form of graphene, carbon fiber paper, or carbon cloth, among others. A combination of a Pt-based electrocatalyst loaded on a catalyst support can be referred to as an electrode material. In some embodiments, the catalyst support is subjected to reductive treatment to impart improved performance to the Pt-based electrocatalyst.

In some embodiments, a Pt-based electrocatalyst can be formed according to a manufacturing method including: (1) subjecting a catalyst support to reductive treatment; and (2) subsequent to (1), reacting a Pt-containing precursor and a N-containing precursor in a liquid medium in the presence of the catalyst support to form PtN nanostructures affixed to the catalyst support.

In some embodiments, (1) includes annealing the catalyst support in a reducing environment, such as by exposure to an atmosphere of hydrogen gas (H₂) and an inert gas, such as Argon (Ar). H₂ can constitute at least about 5% (by mole) of all gases to which the catalyst support is exposed during reductive treatment, such as at least about 10% and up to about 40% or more. Annealing can be carried out under conditions of a temperature in a range of about 500° C. to about 1200° C. or about 700° C. to about 1000° C., and a time duration in a range of about 1 hour to about 15 hours or about 4 hours to about 10 hours. In some embodiments, the catalyst support has an initial surface oxygen to carbon (O/C) (atomic) ratio prior to (1), and the catalyst support subsequent to (1) has a subsequent surface O/C (atomic) ratio, and the subsequent O/C ratio is smaller than the initial O/C ratio, such as having a non-value that is up to about 90%, up to about 85%, up to about 80%, up to about 75%, up to about 70%, or up to about 65% of the initial O/C.

Suitable Pt-containing precursors include an organometallic coordination complex of Pt with an organic anion, such as acetylacetonate, and suitable N-containing precursors include an organometallic coordination complex of N with an organic anion, such as acetate. The liquid medium includes one or more solvents, such as one or more organic solvents selected from polar aprotic solvents, polar protic solvents, and non-polar solvents. A solvent that is used should have requisite purity. In some embodiments, a solvent included in the liquid medium also can serve as a reducing agent for reduction of Pt and N, although the inclusion of a separate reducing agent is also contemplated. In some embodiments, a structure-directing agent, such as benzoic acid or other aromatic carboxylic acid, is also included in the liquid medium to promote a desired morphology of Pt-based nanostructures. Reaction can be carried out under agitation and under conditions of a temperature in a range of about 100° C. to about 300° C. or about 100° C. to about 250° C., and a time duration in a range of about 2 hours to about 60 hours or about 10 hours to about 50 hours. The resulting electrocatalyst can be kept in a sealed container for long-term preservation. Also, in some embodiments, the resulting catalyst support (subsequent to (1)) can be kept in a sealed container for long-term preservation.

In additional embodiments, a Pt-based electrocatalyst can be formed according to a manufacturing method including: (1) subjecting a catalyst support to reductive treatment; and (2) subsequent to (1), reacting a Pt-containing precursor, a N-containing precursor, and a M-containing precursor in a liquid medium in the presence of the catalyst support to form PtNM nanostructures affixed to the catalyst support.

In some embodiments, (1) includes annealing the catalyst support in a reducing environment, such as by exposure to an atmosphere of hydrogen gas (H₂) and an inert gas, such as Argon (Ar). H₂ can constitute at least about 5% (by mole) of all gases to which the catalyst support is exposed during reductive treatment, such as at least about 10% and up to about 40% or more. Annealing can be carried out under conditions of a temperature in a range of about 500° C. to about 1200° C. or about 700° C. to about 1000° C., and a time duration in a range of about 1 hour to about 15 hours or about 4 hours to about 10 hours. In some embodiments, the catalyst support has an initial surface O/C (atomic) ratio prior to (1), and the catalyst support subsequent to (1) has a subsequent surface O/C (atomic) ratio, and the subsequent O/C ratio is smaller than the initial O/C ratio, such as having a non-value that is up to about 90%, up to about 85%, up to about 80%, up to about 75%, up to about 70%, or up to about 65% of the initial O/C.

Suitable Pt-containing precursors include an organometallic coordination complex of Pt with an organic anion, such as acetylacetonate, suitable N-containing precursors include an organometallic coordination complex of N with an organic anion, such as acetate, and suitable M-containing precursors include an organometallic coordination complex of M with an organic anion, such as acetate. The liquid medium includes one or more solvents, such as one or more organic solvents selected from polar aprotic solvents, polar protic solvents, and non-polar solvents. A solvent that is used should have requisite purity. In some embodiments, a solvent included in the liquid medium also can serve as a reducing agent for reduction of Pt, N, and M, although the inclusion of a separate reducing agent is also contemplated. In some embodiments, a structure-directing agent, such as benzoic acid or other aromatic carboxylic acid, is also included in the liquid medium to promote a desired morphology of Pt-based nanostructures. Reaction can be carried out under agitation and under conditions of a temperature in a range of about 100° C. to about 300° C. or about 100° C. to about 250° C., and a time duration in a range of about 2 hours to about 60 hours or about 10 hours to about 50 hours. The resulting electrocatalyst can be kept in a sealed container for long-term preservation. Also, in some embodiments, the resulting catalyst support (subsequent to (1)) can be kept in a sealed container for long-term preservation.

In some embodiments, the resulting Pt-based electrocatalyst according to any of the foregoing manufacturing methods is subjected to a post-synthesis treatment. In some embodiments, a post-synthesis treatment includes exposure of the Pt-based electrocatalyst to an acid, such as by adding or otherwise incorporating the Pt-based electrocatalyst in a liquid medium including the acid. Suitable acids include nitric acid, perchloric acid, sulfuric acid, another strong acid (e.g., pKa<−1.6), and combinations thereof. A concentration of the acid in the liquid medium can be in a range of about 0.01 molar (M) to about 1 M or about 0.01 M to about 0.5 M. Exposure to the acid can be carried out under conditions of a temperature in a range of about 30° C. to about 100° C. or about 50° C. to about 80° C., and a time duration in a range of about 1 hour to about 10 hours or about 4 hours to about 8 hours. Exposure to the acid can remove a metal oxide and a metal salt on a surface of the electrocatalyst, which otherwise can be dissolved by protons in a fuel cell operating environment. The dissolved metal oxide or metal salt can introduce cations within a catalyst layer, which can poison a membrane.

Alternatively to or in combination with acid treatment, a post-synthesis treatment of some embodiments includes annealing the Pt-based electrocatalyst in a reducing environment, such as by exposure to an atmosphere of hydrogen gas (H₂) and an inert gas, such as Argon (Ar). Annealing can be carried out under conditions of a temperature in a range of about 100° C. to about 500° C. or about 200° C. to about 400° C., and a time duration in a range of about 10 minutes to about 5 hours or about 10 minutes to about 2 hours. Annealing can form an exterior shell or “skin” of Pt in a Pt-based octahedral catalyst, which can be beneficial in impeding leaching of a transition metal during operation that can lead to membrane poisoning.

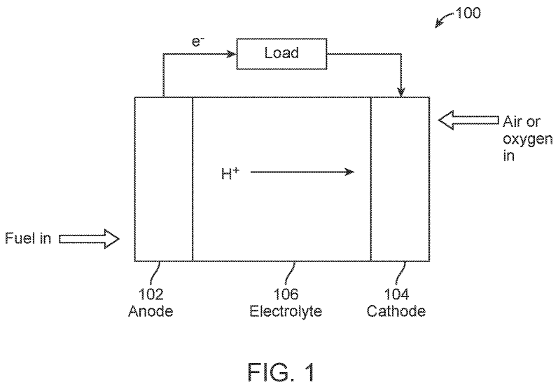

FIG. 1 is a schematic of a fuel cell 100 according to an embodiment of this disclosure. The fuel cell 100 includes an anode 102, a cathode 104, and an electrolyte 106 that is disposed between the anode 102 and the cathode 104. In the illustrated embodiment, the fuel cell 100 is a PEM fuel cell, in which the electrolyte 106 is implemented as a proton-exchange membrane, such as one formed of polytetrafluoroethylene or other suitable fluorinated polymer. During operation of the fuel cell 100, a fuel (such as hydrogen or an alcohol) is oxidized at the anode 102, and oxygen is reduced at the cathode 104. Protons are transported from the anode 102 to the cathode 104 through the electrolyte 106, and electrons are transported over an external circuit load. At the cathode 104, oxygen reacts with the protons and the electrons, forming water and producing heat. Either one, or both, of the anode 102 and the cathode 104 can include an electrocatalyst as set forth in this disclosure.

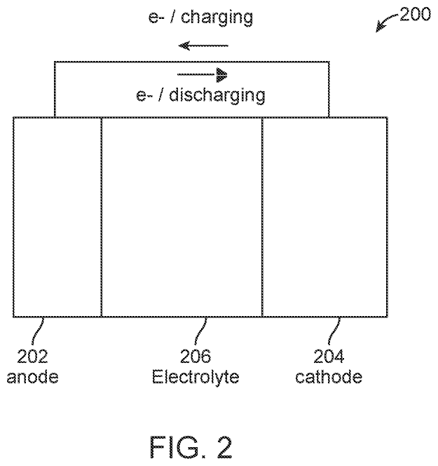

FIG. 2 is a schematic of a metal-air battery 200 according to an embodiment of this disclosure. The battery 200 can operate based on oxidation of lithium at an anode 202 and reduction of oxygen at a cathode 204 to induce a current flow. In the case of a Li-air battery, the anode 202 includes lithium metal, although other metals (e.g., zinc) can be included in place of, or in combination with, lithium metal. An electrolyte 206 is disposed between the anode 202 and the cathode 204, and can be an aprotic electrolyte, although other types of electrolytes are contemplated, such as aqueous, solid state, and mixed aqueous/aprotic electrolytes. The cathode 204 can include an electrocatalyst as set forth in this disclosure.

### EXAMPLES

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

### Methods and Results

### 1. Carbon Engineering

### 1) Carbon Engineering Treatment 1

About 1-2 g of high surface area carbon black powder (Brunauer-Emmett-Teller (BET) surface area of about 750-800 m²/g) is loaded in a quartz boat. The powder is annealed in air at about 200-400° C. for about 1-6 hours. The obtained carbon black is labeled as C-1.

### 2) Carbon Engineering Treatment 2

No specific treatment is performed for treatment 2. The carbon black is labeled as C-2.

### 3) Carbon Engineering Treatment 3

About 1-2 g of high surface area carbon black powder (BET surface area of about 750-800 m²/g) is loaded in a quartz boat. The powder is annealed in a gas atmosphere with about 60%-90% argon (Ar) and about 40%-10% hydrogen (H₂) at about 700-1000° C. for about 4-10 hours. The obtained carbon black is labeled as C-3.

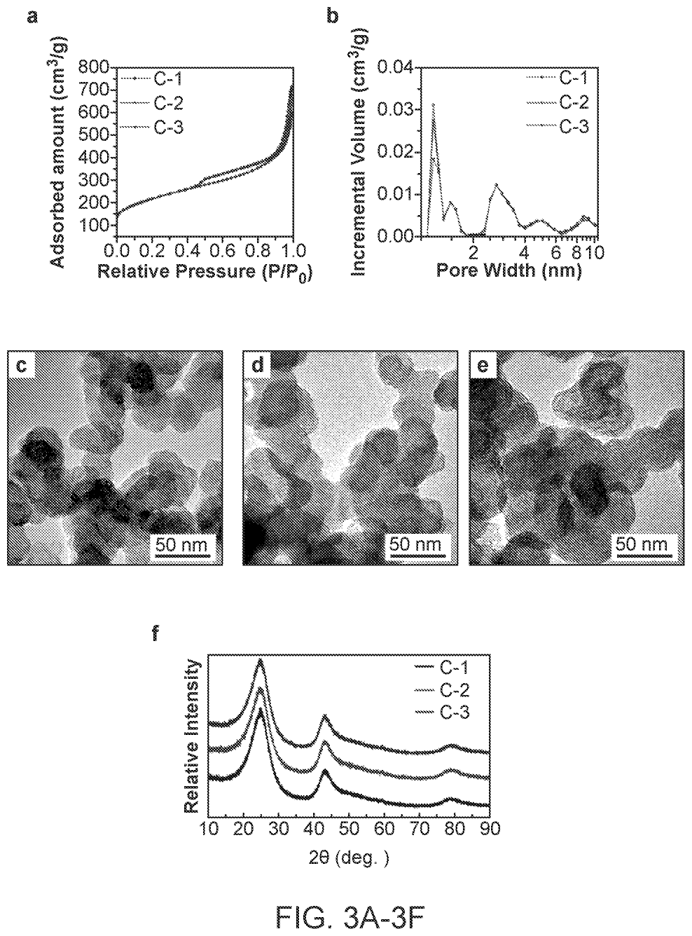

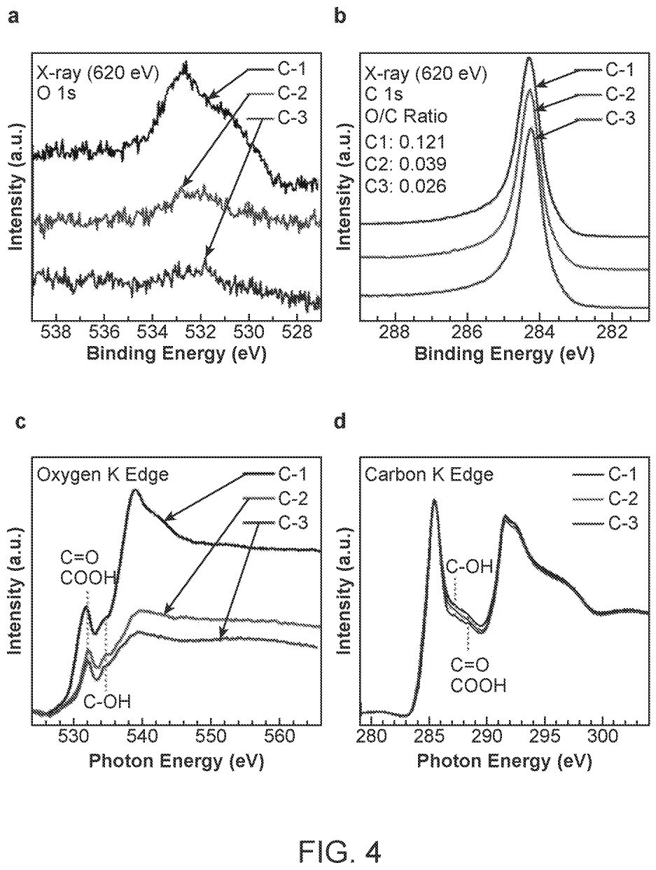

After different treatments, carbon black powders, which are oxidative treated (C-1), without treatment (C-2), reductive treated (C-3), show nearly the same BET surface area and pore size distribution (FIG. 3a,b). Identical carbon morphology and crystalline structure are observed (FIG. 3c-f). However, the surface oxygen ratio is revealed to be different for C-1, C-2, and C-3. The surface oxygen content of carbon materials follows the trend of C-1>C-2 >C-3 (FIG. 4).

### 2. Catalyst Preparation

### 1) PtCo/C

About 600-900 mg of carbon black is dispersed in about 600-900 mL of N,N-dimethylformamide (DMF) under ultrasonication for about 60 mins in an about 1.8-2.5 L pressure vessel. Then about 0.8-1.2 g of platinum(II) acetylacetonate [Pt(acac)₂], about 0.6-0.8 g of cobalt(II) acetate tetrahydrate [Co(ac)₂·4H₂O], and about 6-8 g of benzoic acid are dissolved in about 100 ml of DMF and are also added into the 1.8-2.5 L pressure vessel with the carbon black dispersion. After ultrasonication for about 5 mins, the pressure vessel with the well-mixed solution is placed into an oil bath, and then heated to about 160° C. within about 0.5 hours. The pressure vessel is then kept at about 160° C. for about 48 hours.

After the reaction finished, the catalyst is collected by centrifugation, then redispersed and washed with an isopropanol and acetone mixture. Then the catalyst is dried in vacuum at room temperature. After the catalyst is substantially completely dried, the dried catalyst is annealed in about 200-400° C. under H2 and Ar gas mixture (H₂/Ar volume ratio: about 1/1000 to about 2/500) in atmospheric pressure.

Then the obtained catalyst is dispersed in about 100-200 mL of about 0.01 M-0.5 M H₂SO₄ in an about 200-400 ml bottle. The bottle is kept at about 50-80° C. for about 4-8 hours. After the acid wash, the catalyst is washed by deionized water for 3-5 times, and then dried in vacuum. The dried catalyst was then annealed at about 200-400° C. for about 2 hours in Ar and H₂ mixture (H₂/Ar volume ratio: about 1/1000 to about 2/500) in atmospheric pressure.

### 2) PtNi/C

About 600-900 mg of carbon black is dispersed in about 600-900 mL of DMF under ultrasonication for about 60 mins in an about 1.8-2.5 L pressure vessel. Then about 0.8-1.2 g of Pt(acac)₂, about 0.6-0.8 g of nickel(II) acetate tetrahydrate [Ni(ac)₂·4H₂O], about 100-200 mg Bis(triphenylphosphine)dicarbonylnickel [(C₆H₅)₃P]₂Ni(CO)₂], about 6-8 g of benzoic acid are dissolved in about 100 ml of DMF and are also added into the 1.8-2.5 L pressure vessel with the carbon black dispersion. After ultrasonication for about 5 mins, the pressure vessel with the well-mixed solution is placed into an oil bath, and then heated to about 160° C. within about 0.5 hours. The pressure vessel is then kept at about 160° C. for about 48 hours.

After the reaction finished, the catalyst is collected by centrifugation, then redispersed and washed with an isopropanol and acetone mixture. Then the catalyst is dried in vacuum at room temperature. After the catalyst is substantially completely dried, the dried catalyst is annealed in about 200-400° C. under Ar/H₂ gas mixture atmosphere. Then the obtained catalyst is dispersed in about 100-200 mL of about 0.01 M-0.5 M H₂SO₄ in an about 200-400 ml bottle. The bottle is kept at about 50-80° C. for about 4-8 hours. After the acid wash, the catalyst is washed by deionized water for 3-5 times, and then dried in vacuum. The dried catalyst was then annealed at about 200-400° C. for about 2 hours in Ar and H₂ mixture (H₂/Ar volume ratio: about 1/1000 to about 2/500) in atmospheric pressure.

### 3. Results of Fuel Cell Performance Test

The catalysts are tested with protocols proposed by the U.S. Department of Energy. The results are summarized below:

Testing of a membrane assembly electrode (MEA) is performed at about 80° C. with a gas pressure of about 150 kPa at both a cathode and an anode. The mass activity of a given catalyst is evaluated with H₂ in the anode and O₂ in the cathode. The high current density performance of the tested catalyst is evaluated with H₂ in the anode and air in the cathode. The test results are listed in Table 1 and demonstrate that carbon engineering with reductive treatment improves the performance of the catalyst.

TABLE 1
MEA test results of catalysts

| | | (H₂/O₂) | (H₂/Air) |
|---|---|---|---|
| Carbon | Cathode | Mass Activity | Current Density |
| Support Type | Pt Loading | at 0.9 V | at 0.675 V |
| for PtM/C | (mg/cm²) | (A/gPt) | (mA/cm²) |
| C-1 | 0.1 | 240-260 | 600-700 |
| C-2 | 0.1 | 350-400 | 900-1100 |
| C-3 | 0.1 | 500-700 | 1100-1250 |

As used herein, the singular terms “a,” “an,” and “the” may include plural referents unless the context clearly dictates otherwise. Thus, for example, reference to an object may include multiple objects unless the context clearly dictates otherwise.

As used herein, the term “set” refers to a collection of one or more objects. Thus, for example, a set of objects can include a single object or multiple objects.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. When referring to a first numerical value as “substantially” or “about” the same as a second numerical value, the terms can refer to the first numerical value being within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claim(s). In addition, many modifications may be made to adapt a particular situation, material, composition of matter, method, operation or operations, to the objective, spirit and scope of the disclosure. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

1. A manufacturing method comprising:
subjecting a catalyst support to reductive treatment; and
reacting a Pt-containing precursor and a N-containing precursor in a liquid medium in the presence of the catalyst support to form PtN nanostructures affixed to the catalyst support.

2. The manufacturing method of claim 1, wherein the catalyst support is a carbonaceous support.

3. The manufacturing method of claim 1, wherein subjecting the catalyst support to reductive treatment includes annealing the catalyst support in a reducing environment.

4. The manufacturing method of claim 1, wherein the catalyst support has an initial surface oxygen to carbon (O/C) atomic ratio prior to reductive treatment, and the catalyst support subsequent to reductive treatment has a subsequent surface O/C atomic ratio, and the subsequent surface O/C atomic ratio is smaller than the initial surface O/C atomic ratio.

5. The manufacturing method of claim 1, wherein N is Ni, Co, Cu, or Ag.

6. The manufacturing method of claim 1, further comprising annealing the PtN nanostructures affixed to the catalyst support in a reducing environment.

7. The manufacturing method of claim 1, further comprising exposing the PtN nanostructures affixed to the catalyst support to an acid.

8. A manufacturing method comprising:
subjecting a catalyst support to reductive treatment; and
reacting a Pt-containing precursor, a N-containing precursor, and a M-containing precursor in a liquid medium in the presence of the catalyst support to form PtNM nanostructures affixed to the catalyst support.

9. The manufacturing method of claim 8, wherein the catalyst support is a carbonaceous support.

10. The manufacturing method of claim 8, wherein subjecting the catalyst support to reductive treatment includes annealing the catalyst support in a reducing environment.

11. The manufacturing method of claim 8, wherein the catalyst support has an initial surface oxygen to carbon (O/C) atomic ratio prior to reductive treatment, and the catalyst support subsequent to reductive treatment has a subsequent surface O/C atomic ratio, and the subsequent surface O/C atomic ratio is smaller than the initial surface O/C atomic ratio.

12. The manufacturing method of claim 8, wherein N is Ni, Co, Cu, or Ag, and M is a transition metal different from N.

13. The manufacturing method of claim 8, wherein N and M are different transitional metals selected from Ni, Co, Cu, and Ag.

14. The manufacturing method of claim 8, further comprising annealing the PtNM nanostructures affixed to the catalyst support in a reducing environment.

15. The manufacturing method of claim 8, further comprising exposing the PtNM nanostructures affixed to the catalyst support to an acid.
